(19) United States
(12) Patent Application Publication
(10) Pub. No.: US 2015/0234669 A1
(43) Pub. Date: Aug. 20, 2015

(54) MEMORY RESOURCE SHARING AMONG MULTIPLE COMPUTE NODES

(71) Applicant: Strato Scale Ltd., Herzlia (IL)

(72) Inventors: Muli Ben-Yehuda, Haifa (IL); Etay Bogner, Tel Aviv (IL); Ariel Maislos, Bnei Zion (IL); Shlomo Matichin, Petach Tikva (IL)

(73) Assignee: Strato Scale Ltd., Herzlia (IL)

(21) Appl. No.: 14/181,791

(22) Filed: Feb. 17, 2014

(51) Int. Cl. G06F 9/455; H04L 29/08; G06F 3/06

(52) U.S. Cl. CPC G06F 9/45533; G06F 3/0604; G06F 3/0665; G06F 3/067; H04L 67/1097

(57) ABSTRACT

A method includes running on multiple compute nodes respective memory sharing agents that communicate with one another over a communication network. One or more local Virtual Machines (VMs), which access memory pages, run on a given compute node. Using the memory sharing agents, the memory pages that are accessed by the local VMs are stored on at least two of the compute nodes, and the stored memory pages are served to the local VMs.

### FIELD OF THE INVENTION

The present invention relates generally to computing systems, and particularly to methods and systems for resource sharing among compute nodes.

### BACKGROUND OF THE INVENTION

Machine virtualization is commonly used in various computing environments, such as in data centers and cloud computing. Various virtualization solutions are known in the art. For example, VMware, Inc. (Palo Alto, Calif.), offers virtualization software for environments such as data centers, cloud computing, personal desktop and mobile computing.

U.S. Pat. No. 8,266,238, whose disclosure is incorporated herein by reference, describes an apparatus including a physical memory configured to store data and a chipset configured to support a virtual machine monitor (VMM). The VMM is configured to map virtual memory addresses within a region of a virtual memory address space of a virtual machine to network addresses, to trap a memory read or write access made by a guest operating system, to determine that the memory read or write access occurs for a memory address that is greater than the range of physical memory addresses available on the physical memory of the apparatus, and to forward a data read or write request corresponding to the memory read or write access to a network device associated with the one of the plurality of network addresses corresponding to the one of the plurality of the virtual memory addresses.

U.S. Pat. No. 8,082,400, whose disclosure is incorporated herein by reference, describes firmware for sharing a memory pool that includes at least one physical memory in at least one of plural computing nodes of a system. The firmware partitions the memory pool into memory spaces allocated to corresponding ones of at least some of the computing nodes, and maps portions of the at least one physical memory to the memory spaces. At least one of the memory spaces includes a physical memory portion from another one of the computing nodes.

U.S. Pat. No. 8,544,004, whose disclosure is incorporated herein by reference, describes a cluster-based operating system-agnostic virtual computing system. In an embodiment, a cluster-based collection of nodes is realized using conventional computer hardware. Software is provided that enables at least one VM to be presented to guest operating systems, wherein each node participating with the virtual machine has its own emulator or VMM. VM memory coherency and I/O coherency are provided by hooks, which result in the manipulation of internal processor structures. A private network provides communication among the nodes.

### SUMMARY OF THE INVENTION

An embodiment of the present invention that is described herein provides a method including running on multiple compute nodes respective memory sharing agents that communicate with one another over a communication network. One or more local Virtual Machines (VMs), which access memory pages, run on a given compute node. Using the memory sharing agents, the memory pages that are accessed by the local VMs are stored on at least two of the compute nodes, and the stored memory pages are served to the local VMs.

In some embodiments, running the memory sharing agents includes classifying the memory pages accessed by the local VMs into commonly-accessed memory pages and rarely-accessed memory pages in accordance with a predefined criterion, and processing only the rarely-accessed memory pages using the memory sharing agents. In some embodiments, running the memory sharing agents includes classifying the memory pages stored on the given compute node into memory pages that are mostly written to and rarely read by the local VMs, memory pages that are mostly read and rarely written to by the local VMs, and memory pages that are rarely written to and rarely read by the local VMs, and deciding whether to export a given memory page from the given compute node based on a classification of the given memory page.

In a disclosed embodiment, storing the memory pages includes introducing a memory page to the memory sharing agents, defining one of the memory sharing agents as owning the introduced memory page, and storing the introduced memory page using the one of the memory sharing agents. In an embodiment, running the memory sharing agents includes retaining no more than a predefined number of copies of a given memory page on the multiple compute nodes.

In another embodiment, storing the memory pages includes, in response to a memory pressure condition in the given compute node, selecting a memory page that is stored on the given compute node, and, subject to verifying using the memory sharing agents that at least a predefined number of copies of the selected memory page are stored across the multiple compute nodes, deleting the selected memory page from the given compute node. In yet another embodiment, storing the memory pages includes, in response to a memory pressure condition in the given compute node, selecting a memory page that is stored on the given compute node and exporting the selected memory page using the memory sharing agents to another compute node.

In an embodiment, serving the memory pages includes, in response to a local VM accessing a memory page that is not stored on the given compute node, fetching the memory page using the memory sharing agents. Fetching the memory page may include sending a query, from a local memory sharing agent of the given compute node to a first memory sharing agent of a first compute node that is defined as owning the memory page, for an identity of a second compute node on which the memory page is stored, and requesting the memory page from the second compute node. In an embodiment, fetching the memory page includes, irrespective of sending the query, requesting the memory page from a compute node that is known to store a copy of the memory page.

There is additionally provided, in accordance with an embodiment of the present invention, a system including multiple compute nodes including respective memories and respective processors, wherein a processor of a given compute node is configured to run one or more local Virtual Machines (VMs) that access memory pages, and wherein the processors are configured to run respective memory sharing agents that communicate with one another over a communication network, and, using the memory sharing agents, to store the memory pages that are accessed by the local VMs on at least two of the compute nodes and serve the stored memory pages to the local VMs.

There is also provided, in accordance with an embodiment of the present invention, a compute node including a memory and a processor. The processor is configured to run one or more local Virtual Machines (VMs) that access memory pages, and to run a memory sharing agent that communicates over a communication network with one or more other memory sharing agents running on respective other compute nodes, so as to store the memory pages that are accessed by the local VMs in the memory of the compute node and on at least one of the other compute nodes, and so as to serve the stored memory pages to the local VMs.

There is further provided, in accordance with an embodiment of the present invention, a computer software product, the product including a tangible non-transitory computer-readable medium in which program instructions are stored, which instructions, when read by a processor of a compute node that runs one or more local Virtual Machines (VMs) that access memory pages, cause the processor to run a memory sharing agent that communicates over a communication network with one or more other memory sharing agents running on respective other compute nodes, so as to store the memory pages that are accessed by the local VMs in a memory of the compute node and on at least one of the other compute nodes, and so as to serve the stored memory pages to the local VMs.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a cluster of compute nodes, in accordance with an embodiment of the present invention;

FIG. 2 is a diagram that schematically illustrates criteria for retaining or exporting memory pages, in accordance with an embodiment of the present invention;

FIG. 3 is a diagram that schematically illustrates a distributed memory sharing architecture, in accordance with an embodiment of the present invention;

FIG. 4 is a flow chart that schematically illustrates a background process for sharing memory pages across a cluster of compute nodes, in accordance with an embodiment of the present invention;

FIG. 5 is a flow chart that schematically illustrates a method for mitigating memory pressure in a compute node, in accordance with an embodiment of the present invention;

FIG. 6 is a flow chart that schematically illustrates a method for fetching a memory page to a compute node, in accordance with an embodiment of the present invention; and

FIG. 7 is a state diagram that schematically illustrates the life-cycle of a memory page, in accordance with an embodiment of the present invention.

### DETAILED DESCRIPTION OF EMBODIMENTS

### Overview

Various computing systems, such as data centers, cloud computing systems and High-Performance Computing (HPC) systems, run Virtual Machines (VMs) over a cluster of compute nodes connected by a communication network. In many practical cases, the major bottleneck that limits VM performance is lack of available memory. When using conventional virtualization solutions, the average utilization of a node tends to be on the order of 10% or less, mostly due to inefficient use of memory. Such a low utilization means that the expensive computing resources of the nodes are largely idle and wasted.

Embodiments of the present invention that are described herein provide methods and systems for cluster-wide sharing of memory resources. The methods and systems described herein enable a VM running on a given compute node to seamlessly use memory resources of other nodes in the cluster. In particular, nodes experiencing memory pressure are able to exploit memory resources of other nodes having spare memory.

In some embodiments, each node runs a respective memory sharing agent, referred to herein as a Distributed Page Store (DPS) agent. The DPS agents, referred to collectively as a DPS network, communicate with one another so as to coordinate distributed storage of memory pages. Typically, each node aims to retain in its local memory only a small number of memory pages that are accessed frequently by the local VMs. Other memory pages may be introduced to the DPS network as candidates for possible eviction from the node. Introduction of memory pages to the DPS network is typically performed in each node by the local hypervisor, as a background process.

The DPS network may evict a previously-introduced memory page from a local node in various ways. For example, if a sufficient number of copies of the page exist cluster-wide, the page may be deleted from the local node. This process is referred to as de-duplication. If the number of copies of the page does not permit de-duplication, the page may be exported to another node. The latter process is referred to as remote swap. An example memory sharing architecture, and example de-duplication and remote swap processes, are described in detail below. An example “page-in” process that fetches a remotely-stored page for use by a local VM is also described.

The methods and systems described herein resolve the memory availability bottleneck that limits cluster node utilization. When using the disclosed techniques, a cluster of a given computational strength can execute heavier workloads. Alternatively, a given workload can be executed using a smaller and less expensive cluster. In either case, the cost-effectiveness of the cluster is considerably improved. The performance gain of the disclosed techniques is particularly significant for large clusters that operate many VMs, but the methods and systems described herein can be used with any suitable cluster size or environment.

### System Description

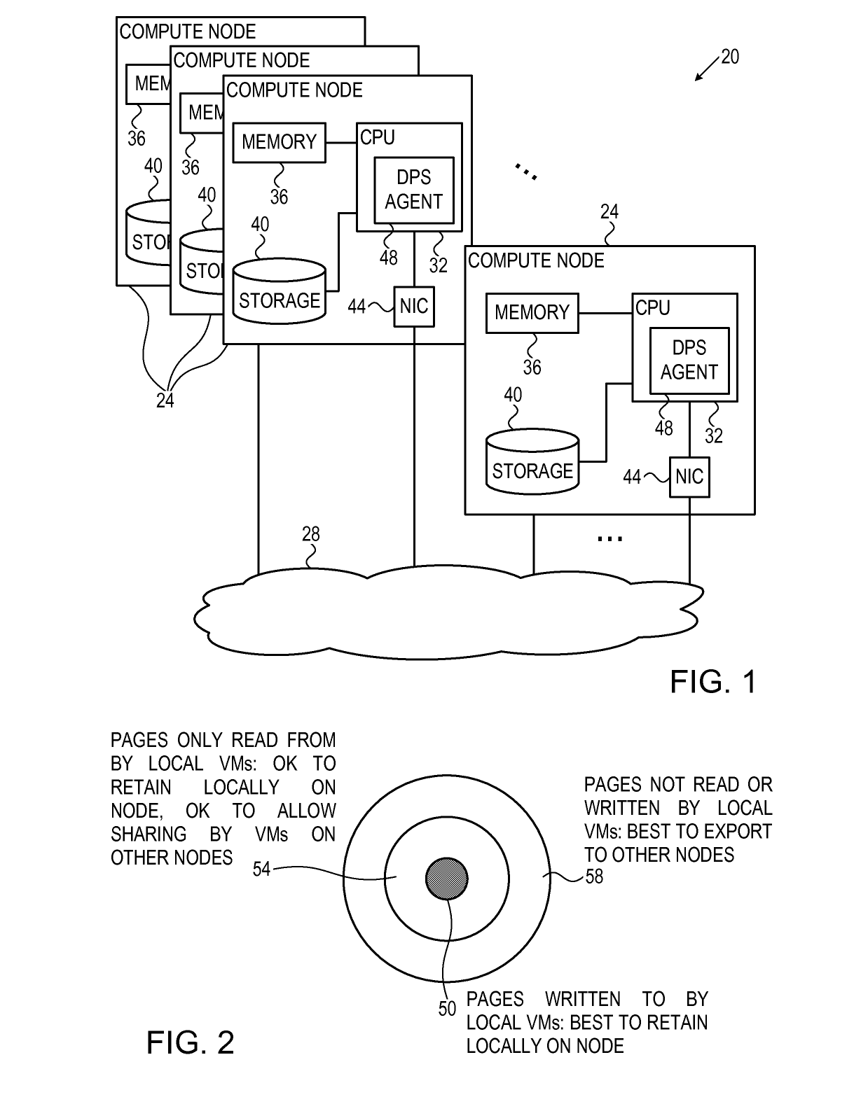

FIG. 1 is a block diagram that schematically illustrates a computing system 20, which comprises a cluster of multiple compute nodes 24, in accordance with an embodiment of the present invention. System 20 may comprise, for example, a data center, a cloud computing system, a High-Performance Computing (HPC) system or any other suitable system.

Compute nodes 24 (referred to simply as “nodes” for brevity) typically comprise servers, but may alternatively comprise any other suitable type of compute nodes. System 20 may comprise any suitable number of nodes, either of the same type or of different types. Nodes 24 are connected by a communication network 28, typically a Local Area Network (LAN). Network 28 may operate in accordance with any suitable network protocol, such as Ethernet or Infiniband.

Each node 24 comprises a Central Processing Unit (CPU) 32. Depending on the type of compute node, CPU 32 may comprise multiple processing cores and/or multiple Integrated Circuits (ICs). Regardless of the specific node configuration, the processing circuitry of the node as a whole is regarded herein as the node CPU. Each node further comprises a memory 36 (typically a volatile memory such as Dynamic Random Access Memory—DRAM) and a Network Interface Card (NIC) 44 for communicating with network 28. Some of nodes 24 (but not necessarily all nodes) comprise a non-volatile storage device 40 (e.g., a magnetic Hard Disk Drive—HDD—or Solid State Drive—SSD).

Nodes 24 typically run Virtual Machines (VMs) that in turn run customer applications. In some embodiments, a VM that runs on a given node accesses memory pages that are stored on multiple nodes. For the purpose of sharing memory resources among nodes 24, the CPU of each node runs a Distributed Page Store (DPS) agent 48. DPS agents 48 in the various nodes communicate with one another over network 28 for coordinating storage of memory pages, as will be explained in detail below. The multiple DPS agents are collectively referred to herein as a “DPS network.” DPS agents 48 are also referred to as “DPS daemons,” “memory sharing daemons” or simply “agents” or “daemons.” All of these terms are used interchangeably herein.

The system and compute-node configurations shown in FIG. 1 are example configurations that are chosen purely for the sake of conceptual clarity. In alternative embodiments, any other suitable system and/or node configuration can be used. The various elements of system 20, and in particular the elements of nodes 24, may be implemented using hardware/firmware, such as in one or more Application-Specific Integrated Circuit (ASICs) or Field-Programmable Gate Array (FPGAs). Alternatively, some system or node elements, e.g., CPUs 32, may be implemented in software or using a combination of hardware/firmware and software elements. In some embodiments, CPUs 32 comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### System Concept and Rationale

In a typical deployment of system 20, nodes 24 run VMs that in turn run customer applications. Not every node necessarily runs VMs at any given time, and a given node may run a single VM or multiple VMs. Each VM consumes computing resources, e.g., CPU, memory, storage and network communication resources. In many practical scenarios, the prime factor that limits system performance is lack of memory. In other words, lack of available memory often limits the system from running more VMs and applications.

In some embodiments of the present invention, a VM that runs on a given node 24 is not limited to use only memory 36 of that node, but is able to use available memory resources in other nodes. By sharing memory resources across the entire node cluster, and adapting the sharing of memory over time, the overall memory utilization is improved considerably. As a result, a node cluster of a given size is able to handle more VMs and applications. Alternatively, a given workload can be carried out by a smaller cluster.

In some cases, the disclosed techniques may cause slight degradation in the performance of an individual VM, in comparison with a conventional solution that stores all the memory pages used by the VM in the local node. This degradation, however, is usually well within the Service Level Agreement (SLA) defined for the VM, and is well worth the significant increase in resource utilization. In other words, by permitting a slight tolerable degradation in the performance of individual VMs, the disclosed techniques enable a given compute-node cluster to run a considerably larger number of VMs, or to run a given number of VMs on a considerably smaller cluster.

Sharing of memory resources in system 20 is carried out and coordinated by the DPS network, i.e., by DPS agents 48 in the various nodes. The DPS network makes memory sharing transparent to the VMs: A VM accesses memory pages irrespective of the actual physical node on which they are stored.

In the description that follows, the basic memory unit is a memory page. Memory pages are sometimes referred to simply as “pages” for the sake of brevity. The size of a memory page may differ from one embodiment to another, e.g., depending on the Operating System (OS) being used. A typical page size is 4 KB, although any other suitable page sizes (e.g., 2 MB or 4 MB) can be used.

In order to maximize system performance, system 20 classifies the various memory pages accessed by the VMs, and decides in which memory 36 (i.e., on which node 24) to store each page. The criteria governing these decisions consider, for example, the usage or access profile of the pages by the VMs, as well as fault tolerance (i.e., retaining a sufficient number of copies of a page on different nodes to avoid loss of data).

In some embodiments, not all memory pages are processed by the DPS network, and some pages may be handled locally by the OS of the node. The classification of pages and the decision whether to handle a page locally or share it are typically performed by a hypervisor running on the node—To be described further below.

In an example embodiment, each node classifies the memory pages accessed by its local VMs in accordance with some predefined criterion. Typically, the node classifies the pages into commonly-accessed pages and rarely-accessed pages. The commonly-accessed pages are stored and handled locally on the node by the OS. The rarely-accessed pages are introduced to the DPS network, using the local DPS agent of the node, for potential exporting to other nodes. In some cases, pages accessed for read and pages accessed for write are classified and handled differently, as will be explained below.

The rationale behind this classification is that it is costly (e.g., in terms of latency and processing load) to store a commonly-accessed page on a remote node. Storing a rarely-used page on a remote node, on the other hand, will have little impact on performance. Additionally or alternatively, system 20 may use other, finer-granularity criteria.

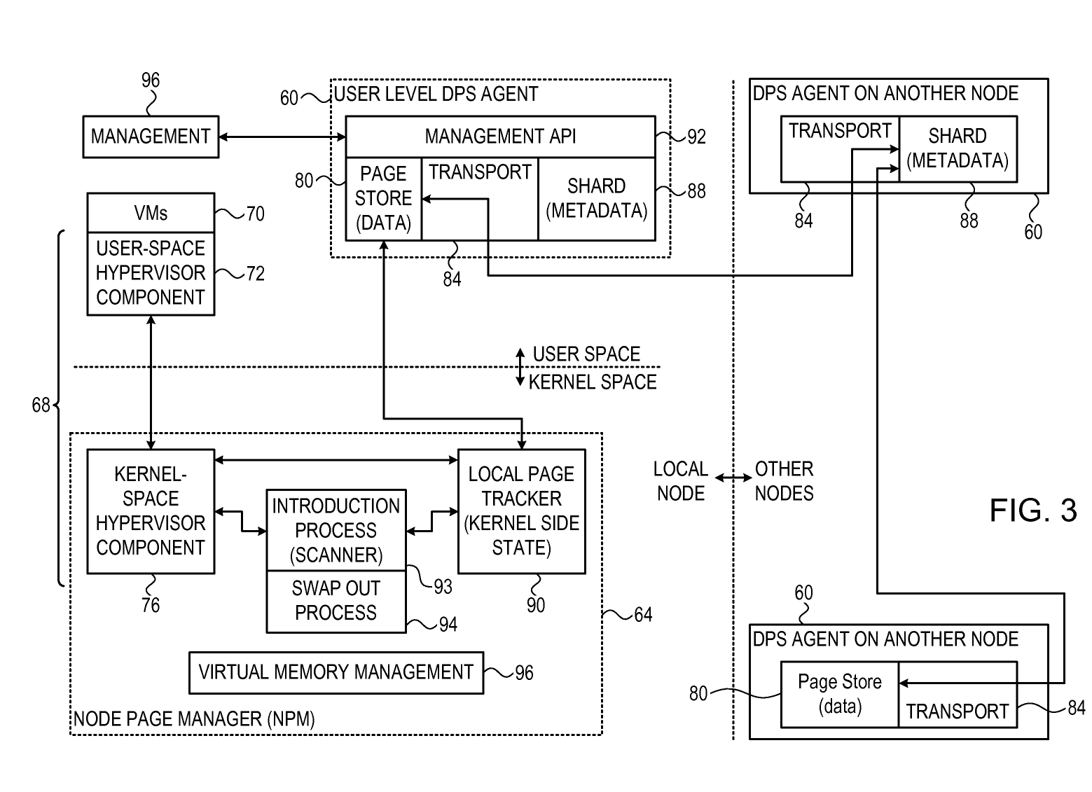

FIG. 2 is a diagram that schematically illustrates example criteria for retaining or exporting memory pages, in accordance with an embodiment of the present invention. In this example, each node classifies the memory pages into three classes: A class 50 comprises the pages that are written to (and possibly read from) by the local VMs, a class 54 comprises the pages that are mostly (e.g., only) read from and rarely (e.g., never) written to by the local VMs, and a class 58 comprises the pages that are rarely (e.g., never) written to or read from by the local VMs. Over time, pages may move from one class to another depending on their access statistics.

The node handles the pages of each class differently. For example, the node tries to store the pages in class 50 (pages written to by local VMs) locally on the node. The pages in class 54 (pages that are only read from by local VMs) may be retained locally but may also be exported to other nodes, and may be allowed to be accessed by VMs running on other nodes if necessary. The node attempts to export the pages in class 58 (pages neither written to nor read from by the local VMs) to other nodes as needed.

In most practical cases, class 50 is relatively small, class 54 is of intermediate size, and class 58 comprises the vast majority of pages. Therefore, when using the above criteria, each node retains locally only a small number of commonly-accessed pages that are both read from and written to. Other pages can be mobilized to other nodes as needed, without considerable performance penalty.

It should be noted that the page classifications and sharing criteria given above are depicted purely by way of example. In alternative embodiments, any other suitable sharing criteria and/or classifications can be used. Moreover, the sharing criteria and/or classifications are regarded as a goal or guideline, and the system may deviate from them if needed.

### Example Memory Sharing Architecture

FIG. 3 is a diagram that schematically illustrates the distributed memory sharing architecture used in system 20, in accordance with an embodiment of the present invention. The left-hand-side of the figure shows the components running on the CPU of a given node 24, referred to as a local node. Each node 24 in system 20 is typically implemented in a similar manner. The right-hand-side of the figure shows components of other nodes that interact with the local node. In the local node (left-hand-side of the figure), the components are partitioned into a kernel space (bottom of the figure) and user space (top of the figure). The latter partitioning is mostly implementation-driven and not mandatory.

In the present example, each node runs a respective user-space DPS agent 60, similar in functionality to DPS agent 48 in FIG. 1 above, and a kernel-space Node Page Manager (NPM) 64. The node runs a hypervisor 68, which is partitioned into a user-space hypervisor component 72 and a kernel-space hypervisor component 76. In the present example, although not necessarily, the user-space hypervisor component is based on QEMU, and the kernel-space hypervisor component is based on Linux/KVM. Hypervisor 68 runs one or more VMs 78 and provides the VMs with resources such as memory, storage and CPU resources.

DPS agent 60 comprises three major components—a page store 80, a transport layer 84 and a shard component 88. Page store 80 holds the actual content (data) of the memory pages stored on the node. Transport layer 84 is responsible for communicating and exchanging pages with peer transport layers 84 of other nodes. A management Application Programming Interface (API) 92 in DPS agent 60 communicates with a management layer 96.

Shard 88 holds metadata of memory pages. The metadata of a page may comprise, for example, the storage location of the page and a hash value computed over the page content. The hash value of the page is used as a unique identifier that identifies the page (and its identical copies) cluster-wide. The hash value is also referred to as Global Unique Content ID (GUCID). Note that hashing is just an example form of signature or index that may be used for indexing the page content. Alternatively, any other suitable signature or indexing scheme can be used.

Jointly, shards 88 of all nodes 24 collectively hold the metadata of all the memory pages in system 20. Each shard 88 holds the metadata of a subset of the pages, not necessarily the pages stored on the same node. For a given page, the shard holding the metadata for the page is defined as “owning” the page. Various techniques can be used for assigning pages to shards. In the present example, each shard 88 is assigned a respective range of hash values, and owns the pages whose hash values fall in this range.

From the point of view of shard 88, for a given owned page, each node 24 may be in one of three roles:
“Origin”—The page is stored (possibly in compressed form) in the memory of the node, and is used by at least one local VM.
“Storage”—The page is stored (possibly in compressed form) in the memory of the node, but is not used by any local VM.
“Dependent”—The page is not stored in the memory of the node, but at least one local VM depends upon it and may access it at any time.

Shard 88 typically maintains three lists of nodes per each owned page—A list of nodes in the “origin” role, a list of nodes in the “storage” role, and a list of nodes in the “dependent” role. Each node 24 may belong to at most one of the lists, but each list may contain multiple nodes.

NPM 64 comprises a kernel-space local page tracker 90, which functions as the kernel-side component of page store 80. Logically, page tracker 90 can be viewed as belonging to DPS agent 60. The NPM further comprises an introduction process 93 and a swap-out process 94. Introduction process 93 introduces pages to the DPS network. Swap out process 94 handles pages that are candidates for exporting to other nodes. The functions of processes 93 and 94 are described in detail further below. A virtual memory management module 96 provides interfaces to the underlying memory management functionality of the hypervisor and/or architecture, e.g., the ability to map pages in and out of a virtual machine's address space.

The architecture and functional partitioning shown in FIG. 3 is depicted purely by way of example. In alternative embodiments, the memory sharing scheme can be implemented in the various nodes in any other suitable way.

### Selective Background Introduction of Pages to DPS Network

In some embodiments, hypervisor 68 of each node 24 runs a background process that decides which memory pages are to be handled locally by the OS and which pages are to be shared cluster-wise using the DPS agents.

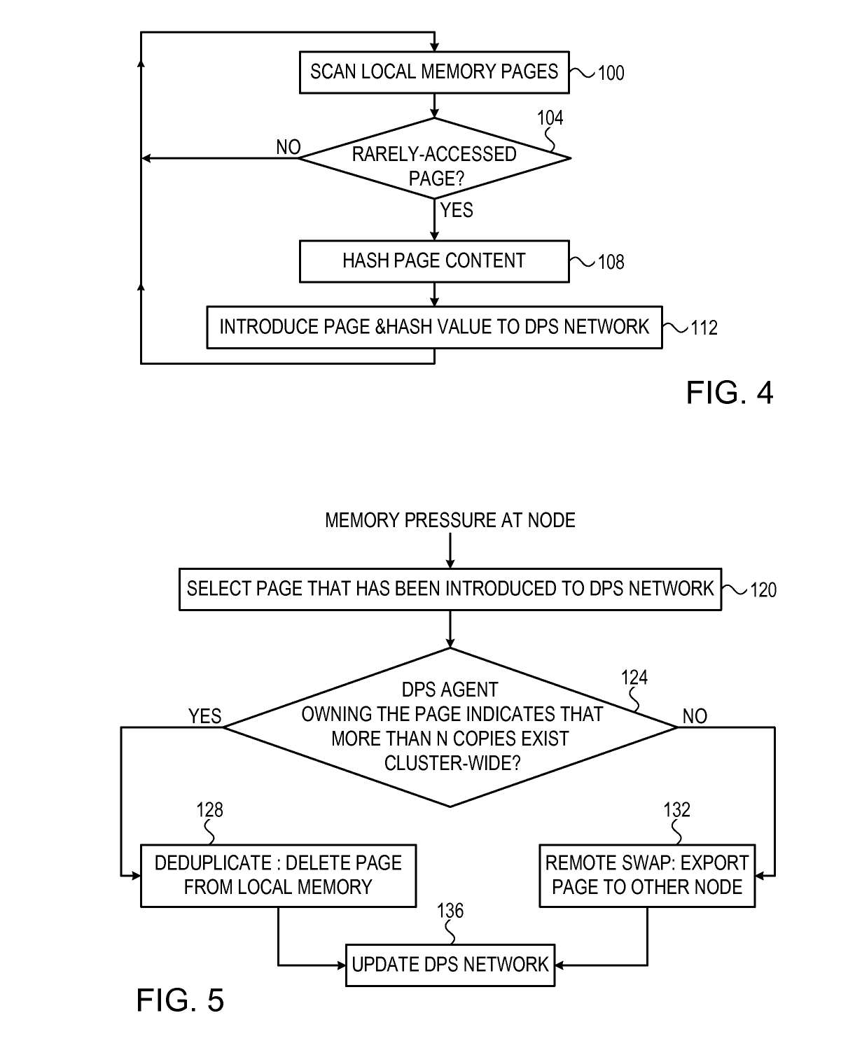

FIG. 4 is a flow chart that schematically illustrates a background process for introducing pages to the DPS network, in accordance with an embodiment of the present invention. Hypervisor 68 of each node 24 continuously scans the memory pages accessed by the local VMs running on the node, at a scanning step 100. For a given page, the hypervisor checks whether the page is commonly-accessed or rarely-accessed, at a usage checking step 104. If the page is commonly-used, the hypervisor continues to store the page locally on the node. The method loops back to step 100 in which the hypervisor continues to scan the memory pages.

If, on the other hand, the page is found to be rarely-used, the hypervisor may decide to introduce the page to the DPS network for possible sharing. The hypervisor computes a hash value (also referred to as hash key) over the page content, and provides the page and the hash value to introducer process 93. The page content may be hashed using any suitable hashing function, e.g., using a SHA1 function that produces a 160-bit (20-byte) hash value.

Introducer process 93 introduces the page, together with the hash value, to the DPS network via the local DPS agent 60. Typically, the page content is stored in page store 80 of the local node, and the DPS agent defined as owning the page (possibly on another node) stores the page metadata in its shard 88. From this point, the page and its metadata are accessible to the DPS agents of the other nodes. The method then loops back to step 100 above.

Hypervisor 68 typically carries out the selective introduction process of FIG. 4 continuously in the background, regardless of whether the node experiences memory pressure or not. In this manner, when the node encounters memory pressure, the DPS network is already aware of memory pages that are candidates for eviction from the node, and can react quickly to resolve the memory pressure.

### Deduplication and Remote Swap as Solutions for Memory Pressure

In some embodiments, DPS agents 60 resolve memory pressure conditions in nodes 24 by running a cluster-wide de-duplication process. In many practical cases, different VMs running on different nodes use memory pages having the same content. For example, when running multiple instances of a VM on different nodes, the memory pages containing the VM kernel code will typically be duplicated multiple times across the node cluster.

In some scenarios it makes sense to retain only a small number of copies of such a page, make these copies available to all relevant VMs, and delete the superfluous copies. This process is referred to as de-duplication. As can be appreciated, de-duplication enables nodes to free local memory and thus relieve memory pressure. De-duplication is typically applied to pages that have already been introduced to the DPS network. As such, de-duplication is usually considered only for pages that are not frequently-accessed.

The minimal number of copies of a given memory page that should be retained cluster-wide depends on fault tolerance considerations. For example, in order to survive single-node failure, it is necessary to retain at least two copies of a given page on different nodes so that if one of them fails, a copy is still available on the other node. Larger numbers can be used to provide a higher degree of fault tolerance at the expense of memory efficiency. In some embodiments, this minimal number is a configurable system parameter in system 20.

Another cluster-wide process used by DPS agents 60 to resolve memory pressure is referred to as remote-swap. In this process, the DPS network moves a memory page from memory 36 of a first node (which experiences memory pressure) to memory 36 of a second node (which has available memory resources). The second node may store the page in compressed form. If the memory pressure is temporary, the swapped page may be returned to the original node at a later time.

FIG. 5 is a flow chart that schematically illustrates a method for mitigating memory pressure in a compute node 24 of system 20, in accordance with an embodiment of the present invention. The method begins when hypervisor 68 of a certain node 24 detects memory pressure, either in the node in general or in a given VM.

In some embodiments, hypervisor 68 defines lower and upper thresholds for the memory size to be allocated to a VM, e.g., the minimal number of pages that must be allocated to the VM, and the maximal number of pages that are permitted for allocation to the VM. The hypervisor may detect memory pressure, for example, by identifying that the number of pages used by a VM is too high (e.g., because the number approaches the upper threshold or because other VMs on the same node compete for memory).

Upon detecting memory pressure, the hypervisor selects a memory page that has been previously introduced to the DPS network, at a page selection step 120. The hypervisor checks whether it is possible to delete the selected page using the de-duplication process. If de-duplication is not possible, the hypervisor reverts to evict the selected page using to another node using the remote-swap process.

The hypervisor checks whether de-duplication is possible, at a de-duplication checking step 124. Typically, the hypervisor queries the local DPS agent 60 whether the cluster-wide number of copies of the selected page is more than N (N denoting the minimal number of copies required for fault tolerance). The local DPS agent sends this query to the DPS agent 60 whose shard 88 is assigned to own the selected page.

If the owning DPS agent reports that more than N copies of the page exist cluster-wide, the local DPS agent deletes the local copy of the page from its page store 88, at a de-duplication step 128. The local DPS agent notifies the owning DPS agent of the de-duplication operation, at an updating step 136. The owning DPS agent updates the metadata of the page in shard 88.

If, on the other hand, the owning DPS agent reports at step 124 that there are N or less copies of the page cluster-wide, the local DPS agent initiates remote-swap of the page, at a remote swapping step 132. Typically, the local DPS agent requests the other DPS agents to store the page. In response, one of the other DPS agent stores the page in its page store 88, and the local DPS agent deletes the page from its page store. Deciding which node should store the page may depend, for example, on the currently available memory resources on the different nodes, the relative speed and capacity of the network between them, the current CPU load on the different nodes, which node may need the content of this page at a later time, or any other suitable considerations. The owning DPS agent updates the metadata of the page in shard 88 at step 136.

In the example above, the local DPS agent reverts to remote-swap if de-duplication is not possible. In an alternative embodiment, if de-duplication is not possible for the selected page, the hypervisor selects a different (previously-introduced) page and attempt to de-duplicate it instead. Any other suitable logic can also be used to prioritize the alternative actions for relieving memory pressure.

In either case, the end result of the method of FIG. 5 is that a memory page used by a local VM has been removed from the local memory 36. When the local VM requests access to this page, the DPS network runs a “page-in” process that retrieves the page from its current storage location and makes it available to the requesting VM.

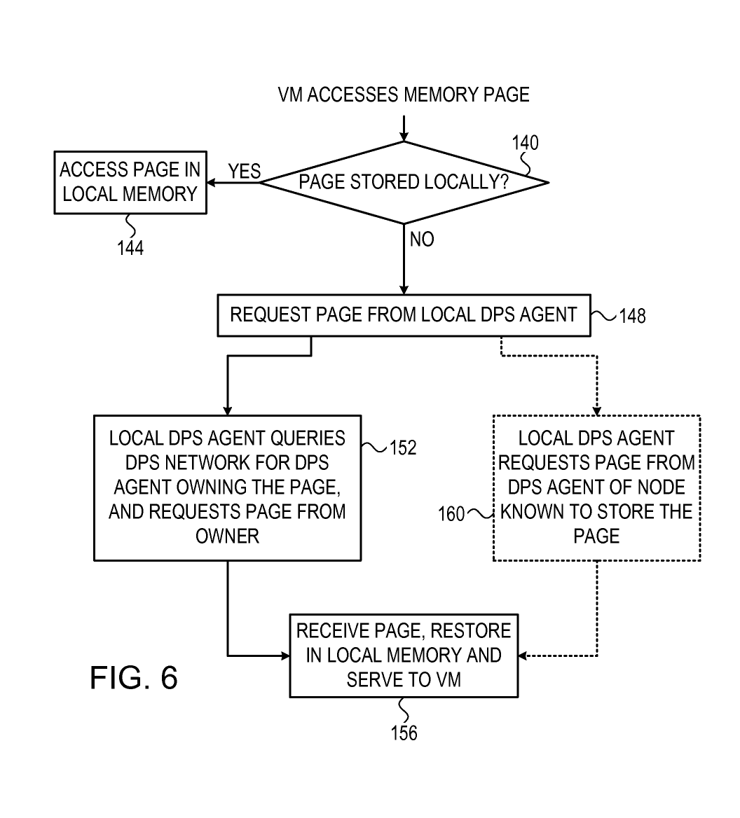

FIG. 6 is a flow chart that schematically illustrates an example page-in process for fetching a remotely-stored memory page to a compute node 24, in accordance with an embodiment of the present invention. The process begins when a VM on a certain node 24 (referred to as local node) accesses a memory page. Hypervisor 68 of the local node checks whether the requested page is stored locally in the node or not, at a location checking step 140. If the page is stored in memory 36 of the local node, the hypervisor fetches the page from the local memory and serves the page to the requesting VM, at a local serving step 144.

If, on the other hand, the hypervisor finds that the requested page is not stored locally, the hypervisor requests the page from the local DPS agent 60, at a page-in requesting step 148. In response to the request, the local DPS agent queries the DPS network to identify the DPS agent that is assigned to own the requested page, and requests the page from the owning DPS agent, at an owner inquiry step 152.

The local DPS agent receives the page from the DPS network, and the local hypervisor restores the page in the local memory 36 and serves the page to the requesting VM, at a remote serving step 156. If the DPS network stores multiple copies of the page for fault tolerance, the local DPS agent is responsible for retrieving and returning a valid copy based on the information provided to it by the owning DPS agent.

In some embodiments, the local DPS agent has prior information as to the identity of the node (or nodes) storing the requested page. In this case, the local DPS agent may request the page directly from the DPS agent (or agents) of the known node (or nodes), at a direct requesting step 160. Step 160 is typically performed in parallel to step 152. Thus, the local DPS agent may receive the requested page more than once. Typically, the owning DPS agent is responsible for ensuring that any node holding a copy of the page will not return an invalid or deleted page. The local DPS agent may, for example, run a multi-stage protocol with the other DPS agents whenever a page state is to be changed (e.g., when preparing to delete a page).

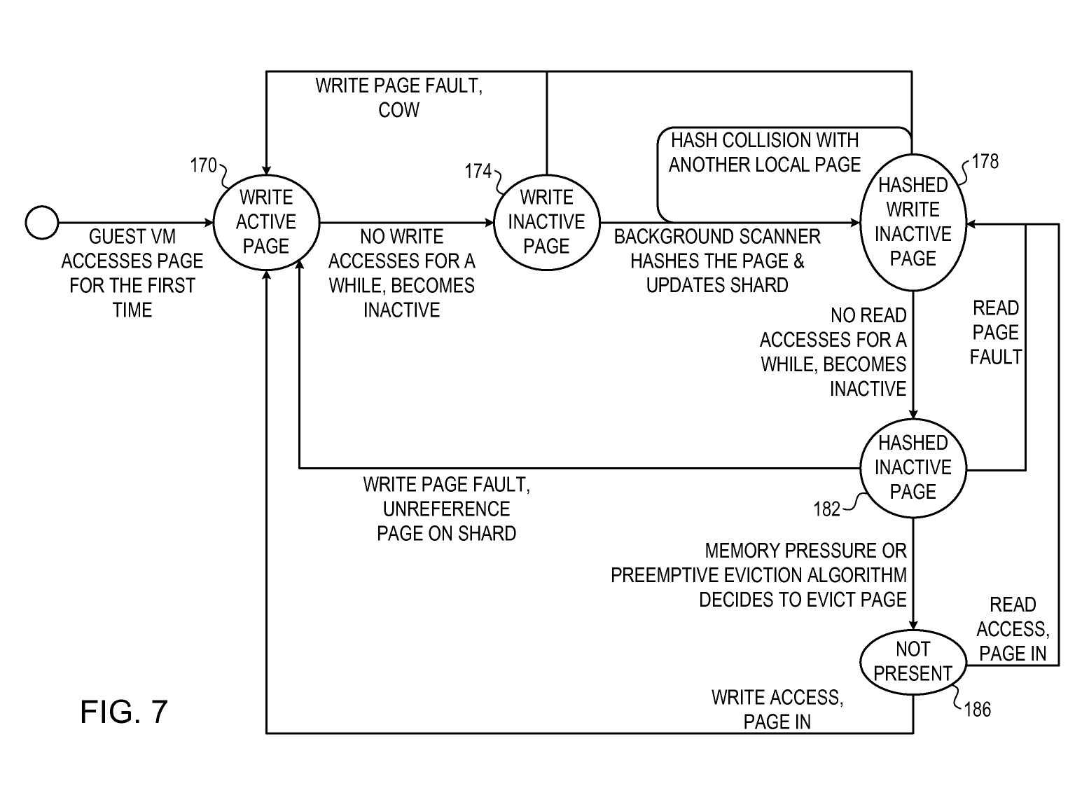

FIG. 7 is a state diagram that schematically illustrates the life-cycle of a memory page, in accordance with an embodiment of the present invention. The life-cycle of the page begins when a VM writes to the page for the first time. The initial state of the page is thus a write-active state 170. As long as the page is written to at frequent intervals, the page remains at this state.

If the page is not written to for a certain period of time, the page transitions to a write-inactive state 174. When the page is hashed and introduced to the DPS network, the page state changes to a hashed write-inactive state 178. If the page is written to when at state 174 (write-inactive) or 178 (hashed write-inactive), the page transitions back to the write-active state 170, and Copy on Write (COW) is performed. If the hash value of the page collides (i.e., coincides) with the hash key of another local page, the collision is resolved, and the two pages are merged into a single page, thus saving memory.

When the page is in hashed write-inactive state 178, if no read accesses occur for a certain period of time, the page transitions to a hashed-inactive state 182. From this state, a read access by a VM will transition the page to write-inactive state 178 (read page fault). A write access by a VM will transition the page to write-active state 170. In this event the page is also removed from the DPS network (i.e., unreferenced by the owning shard 88).

When the page is in hashed-inactive state 182, memory pressure (or a preemptive eviction process) may decide to evict the page (either using de-duplication or remote swap). The page thus transitions to a “not-present” state 186. From state 186, the page may transition to write-active state 170 (in response to a write access or to a write-related page-in request), or to write-inactive state 178 (in response to a read access or to a read-related page-in request).

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
running on multiple compute nodes respective memory sharing agents that communicate with one another over a communication network;
running on a given compute node one or more local Virtual Machines (VMs) that access memory pages; and
using the memory sharing agents, storing the memory pages that are accessed by the local VMs on at least two of the compute nodes, and serving the stored memory pages to the local VMs.

2. The method according to claim 1, wherein running the memory sharing agents comprises classifying the memory pages accessed by the local VMs into commonly-accessed memory pages and rarely-accessed memory pages in accordance with a predefined criterion, and processing only the rarely-accessed memory pages using the memory sharing agents.

3. The method according to claim 1, wherein running the memory sharing agents comprises classifying the memory pages stored on the given compute node into memory pages that are mostly written to and rarely read by the local VMs, memory pages that are mostly read and rarely written to by the local VMs, and memory pages that are rarely written to and rarely read by the local VMs, and deciding whether to export a given memory page from the given compute node based on a classification of the given memory page.

4. The method according to claim 1, wherein storing the memory pages comprises introducing a memory page to the memory sharing agents, defining one of the memory sharing agents as owning the introduced memory page, and storing the introduced memory page using the one of the memory sharing agents.

5. The method according to claim 1, wherein running the memory sharing agents comprises retaining no more than a predefined number of copies of a given memory page on the multiple compute nodes.

6. The method according to claim 1, wherein storing the memory pages comprises, in response to a memory pressure condition in the given compute node, selecting a memory page that is stored on the given compute node, and, subject to verifying using the memory sharing agents that at least a predefined number of copies of the selected memory page are stored across the multiple compute nodes, deleting the selected memory page from the given compute node.

7. The method according to claim 1, wherein storing the memory pages comprises, in response to a memory pressure condition in the given compute node, selecting a memory page that is stored on the given compute node and exporting the selected memory page using the memory sharing agents to another compute node.

8. The method according to claim 1, wherein serving the memory pages comprises, in response to a local VM accessing a memory page that is not stored on the given compute node, fetching the memory page using the memory sharing agents.

9. The method according to claim 8, wherein fetching the memory page comprises sending a query, from a local memory sharing agent of the given compute node to a first memory sharing agent of a first compute node that is defined as owning the memory page, for an identity of a second compute node on which the memory page is stored, and requesting the memory page from the second compute node.

10. The method according to claim 9, wherein fetching the memory page comprises, irrespective of sending the query, requesting the memory page from a compute node that is known to store a copy of the memory page.

11. A system comprising multiple compute nodes comprising respective memories and respective processors,
wherein a processor of a given compute node is configured to run one or more local Virtual Machines (VMs) that access memory pages,
and wherein the processors are configured to run respective memory sharing agents that communicate with one another over a communication network, and, using the memory sharing agents, to store the memory pages that are accessed by the local VMs on at least two of the compute nodes and serve the stored memory pages to the local VMs.

12. The system according to claim 11, wherein the processor is configured to classify the memory pages accessed by the local VMs into commonly-accessed memory pages and rarely-accessed memory pages in accordance with a predefined criterion, and wherein the processors are configured to process only the rarely-accessed memory pages using the memory sharing agents.

13. The system according to claim 11, wherein the processor is configured to classify the memory pages stored on the given compute node into memory pages that are mostly written to and rarely read by the local VMs, memory pages that are mostly read and rarely written to by the local VMs, and memory pages that are rarely written to and rarely read by the local VMs, and to decide whether to export a given memory page from the given compute node based on a classification of the given memory page.

14. The system according to claim 11, wherein the processor is configured to introduce a memory page to the memory sharing agents, and wherein the processors are configured to define one of the memory sharing agents as owning the introduced memory page, and to store the introduced memory page using the one of the memory sharing agents.

15. The system according to claim 11, wherein the processors are configured to retain no more than a predefined number of copies of a given memory page on the multiple compute nodes.

16. The system according to claim 11, wherein, in response to a memory pressure condition in the given compute node, the processors are configured to select a memory page that is stored on the given compute node, and, subject to verifying using the memory sharing agents that at least a predefined number of copies of the selected memory page are stored across the multiple compute nodes, to delete the selected memory page from the given compute node.

17. The system according to claim 11, wherein, in response to a memory pressure condition in the given compute node, the processors are configured to select a memory page that is stored on the given compute node and to export the selected memory page using the memory sharing agents to another compute node.

18. The system according to claim 11, wherein, in response to a local VM accessing a memory page that is not stored on the given compute node, the processors are configured to fetch the memory page using the memory sharing agents.

19. The system according to claim 18, wherein the processors are configured to fetch the memory page by sending a query, from a local memory sharing agent of the given compute node to a first memory sharing agent of a first compute node that is defined as owning the memory page, for an identity of a second compute node on which the memory page is stored, and requesting the memory page from the second compute node.

20. The system according to claim 19, wherein the processors are configured to fetch the memory page by requesting the memory page from a compute node that is known to store a copy of the memory page, irrespective of sending the query.

21. A compute node, comprising:
a memory; and
a processor, which is configured to run one or more local Virtual Machines (VMs) that access memory pages, and to run a memory sharing agent that communicates over a communication network with one or more other memory sharing agents running on respective other compute nodes, so as to store the memory pages that are accessed by the local VMs in the memory of the compute node and on at least one of the other compute nodes, and so as to serve the stored memory pages to the local VMs.

22. A computer software product, the product comprising a tangible non-transitory computer-readable medium in which program instructions are stored, which instructions, when read by a processor of a compute node that runs one or more local Virtual Machines (VMs) that access memory pages, cause the processor to run a memory sharing agent that communicates over a communication network with one or more other memory sharing agents running on respective other compute nodes, so as to store the memory pages that are accessed by the local VMs in a memory of the compute node and on at least one of the other compute nodes, and so as to serve the stored memory pages to the local VMs.
